(19) United States
(12) Patent Application Publication
(10) Pub. No.: US 2016/0106261 A1
(43) Pub. Date: Apr. 21, 2016

(54) Modular Grill Frame With Inserts

(71) Applicant: Magellan Group Ltd., Blaine, WA (US)

(72) Inventors: Andre Dean Cloutier, Blaine, WA (US); Debra Lynne Sasken-Duff, Blaine, WA (US); Edwin Cheong, Blaine, WA (US); Adriana Collins, Blaine, WA (US); Marie Thornton, Blaine, WA (US)

(21) Appl. No.: 14/977,540

(22) Filed: Dec. 21, 2015

Related U.S. Application Data
(63) Continuation-in-part of application No. 13/653,897, filed on Oct. 17, 2012, now Pat. No. 9,215,949.

(51) Int. Cl. A47J 37/06

(52) U.S. Cl. CPC A47J 37/0694

(57) ABSTRACT

Disclosed herein is a modular grilling frame comprising in one example a thermally conductive frame having a longitudinal dimension, a transverse dimension, and a lowermost portion forming a perimeter foot. The modular grilling frame may also provide a transverse divider extending between opposing sides of the perimeter foot. The transverse divider in one example having: a first longitudinal side and a longitudinally opposing second longitudinal side. Also provided in one example is a thermally conductive grilling surface extending between the first longitudinal side of the transverse divider and the portion of the perimeter foot facing the first longitudinal side of the transverse divider. Generally, at least one area bounded by the perimeter foot vertically unobstructed bounded by a surface defining an insert shelf for fitting of a grilling surface such as a griddle panel, grilling panel, perforated plate or mesh panel.

### BACKGROUND OF THE DISCLOSURE

This disclosure claims priority of and is a continuation in part of patent application 13/653897 filed on Oct. 17, 2012 incorporated herein by reference.

### BACKGROUND

1. Field of the Disclosure

This disclosure relates to the field of cookware for frying and/or grilling of food on a heat source such as a BBQ grill.

2. Summary of the Disclosure

Disclosed herein is a combination griddle and grilling frame comprising in one example a thermally conductive frame having a longitudinal dimension, a transverse dimension, and a lowermost portion forming a perimeter foot. The grilling frame of some examples may also provide a transverse divider extending between opposing sides of the perimeter foot. The transverse when utilized having a first longitudinal side and a longitudinally opposing second longitudinal side. Also provided in some examples is a thermally conductive grilling surface extending between the first longitudinal side of the transverse divider and the portion of the perimeter foot facing the first longitudinal side of the transverse divider. This thermally conductive grilling surface is integral to the frame in some examples, and is removable in other examples. Generally, the area bounded by the second longitudinal perimeter foot and the portion of the perimeter foot facing the second longitudinal side is substantially unobstructed and comprises a surface defining an insert shelf for fitting of a grilling surface such as a planar continuous plate, ridged plate, perforated plate, or mesh panel.

The combination griddle and grilling frame as recited above may further comprise a perforated plate fitted within and removably resting upon the insert shelf.

The combination griddle and grilling frame may further comprise a mesh insert fitted within and removably resting upon the insert shelf.

The mesh insert may also comprise an upper grill perimeter frame; a heat resistant mesh extending across and in contact with the upper grill frame; and a lower grill perimeter frame attached to the upper grill frame and in contact with the perimeter of the heat resistant mesh.

The combination griddle and grilling frame as recited above may further comprise at least one cross support vertically below the heat resistant mesh. The cross support in contact with a lower surface of the heat resistant mesh, and attached to the lower grill perimeter frame.

### BRIEF DESCRIPTION OF THE DRAWINGS

FIG. 1 is an isometric view of the disclosed device with the inserts shown separately for clarity of illustration.

FIG. 2 is a top view thereof.

FIG. 3 is a front view thereof with the opposing rear view being a mirror image thereof.

FIG. 4 is a bottom view thereof.

FIG. 5 is a side view thereof with the opposing side view being a mirror image thereof.

FIG. 6 is a cutaway view taken along line 6-6 of FIG. 2.

FIG. 7 is a detail view of the region 7 of FIG. 6.

FIG. 8 is an isometric view of the disclosed device with a perforated insert shown detached.

FIG. 9 is an isometric view thereof with the insert of FIG. 8 with the perforated insert in an operable position.

FIG. 10 is a top view thereof.

FIG. 11 is an isometric view of the disclosed device with a mesh insert shown detached.

FIG. 12 is an isometric view thereof with the insert of FIG. 11 with the mesh insert in an operable position.

FIG. 13 is a top view thereof.

FIG. 14 is an isometric view of the perforated insert.

FIG. 15 is an top view of the mesh insert.

FIG. 16 is a side cutaway view of the mesh insert taken along line 16-16 of FIG. 15.

FIG. 17 is an exploded view of the elements comprising the mesh insert.

FIG. 18 is a front isometric exploded view of another example of the apparatus.

FIG. 19 is an isometric view of the example of FIG. 18 in one configuration.

FIG. 20 is an isometric view of the example of FIG. 18 without a cooking panel attached.

FIG. 21 is a bottom view of the example of FIG. 20.

FIG. 22 is a top view of the example of FIG. 20.

FIG. 23 is a side view of the example of FIG. 20 with the opposing side view being a mirror image thereof.

FIG. 24 is a side cutaway view of the example of FIG. 20.

FIG. 25 is a rear view of the example of FIG. 20.

FIG. 26 is a front view of the example of FIG. 20.

FIG. 27 is an isometric view of a cooking panel as shown in FIG. 18.

FIG. 28 is a top view of the cooking panel shown in FIG. 27.

FIG. 29 is a bottom view of the cooking panel shown in FIG. 27.

FIG. 30 is a side view of the cooking panel shown in FIG. 27.

FIG. 31 is a side cutaway view of the cooking panel shown in FIG. 27.

FIG. 32 is a rear view of the cooking panel shown in FIG. 27.

FIG. 33 is a front view of the cooking panel shown in FIG. 27.

FIG. 34 is an isometric view of a perforated cooking panel as shown in FIG. 18.

FIG. 35 is a top view of the perforated cooking panel as shown in FIG. 34.

FIG. 36 is a bottom view of the perforated cooking panel as shown in FIG. 34.

FIG. 37 is a side view of the perforated cooking panel as shown in FIG. 34.

FIG. 38 is a side cutaway view of the perforated cooking panel as shown in FIG. 34.

FIG. 39 is a front isometric exploded view of another example of the apparatus.

FIG. 40 is an isometric view of the example of FIG. 39 in one configuration.

FIG. 41 is an isometric view of the apparatus of FIG. 40 without a cooking panel attached.

FIG. 42 is a bottom view of the apparatus of FIG. 41

FIG. 43 is a top view of the apparatus of FIG. 41.

FIG. 44 is a front view of the apparatus of FIG. 41.

FIG. 45 is a front cutaway view of the apparatus of FIG. 41.

FIG. 46 is a side view of the apparatus of FIG. 41 with the opposing side view being a mirror image thereof.

FIG. 47 is a side cutaway view of the apparatus of FIG. 41.

FIG. 48 is an isometric view of a grilling insert component of FIG. 39.

FIG. 49 is a top view of the component of FIG. 48.

FIG. 50 is a bottom view of the component of FIG. 48.

FIG. 51 is a front view of the component of FIG. 48.

FIG. 52 is a front cutaway view of the component of FIG. 48.

FIG. 53 is a rear view of the component of FIG. 48.

FIG. 54 is a right side view of the component of FIG. 48.

FIG. 55 is a left side view of the component of FIG. 48.

FIG. 56 is an isometric view of a griddle insert component of FIG. 39.

FIG. 57 is top view of the component of FIG. 56.

FIG. 58 is bottom view of the component of FIG. 56.

FIG. 59 is a front view of the component of FIG. 56.

FIG. 60 is a front cutaway view of the component of FIG. 56.

FIG. 61 is a rear view of the component of FIG. 56.

FIG. 62 is a right side view of the component of FIG. 56.

FIG. 63 is a left side view of the component of FIG. 56.

FIG. 64 is an isometric view of a griddle insert component of FIG. 39.

FIG. 65 is top view of the component of FIG. 64.

FIG. 66 is bottom view of the component of FIG. 56.

FIG. 67 is a front view of the component of FIG. 56.

FIG. 68 is a front cutaway view of the component of FIG. 56.

FIG. 69 is a rear view of the component of FIG. 56.

FIG. 70 is a right side view of the component of FIG. 56.

FIG. 71 is a left side view of the component of FIG. 56.

### DESCRIPTION OF THE PREFERRED EMBODIMENTS

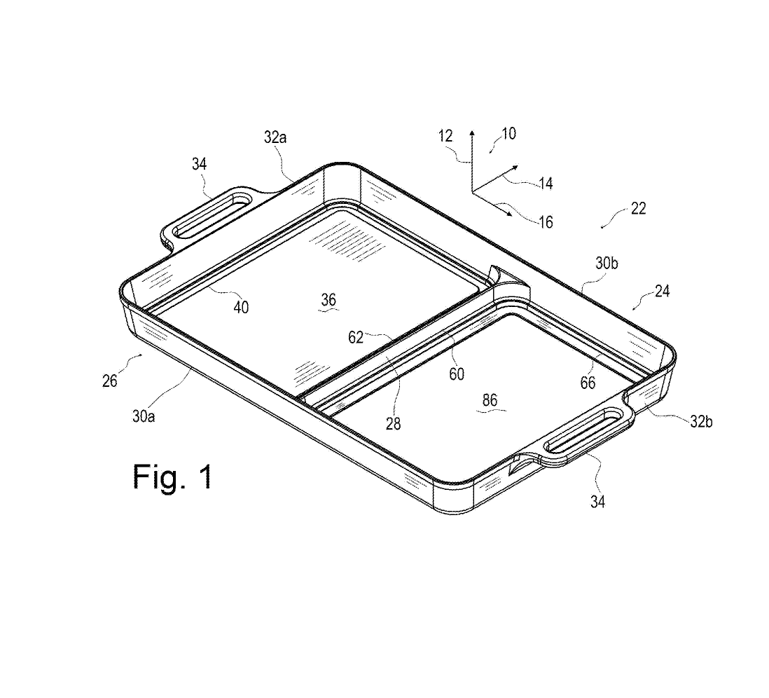

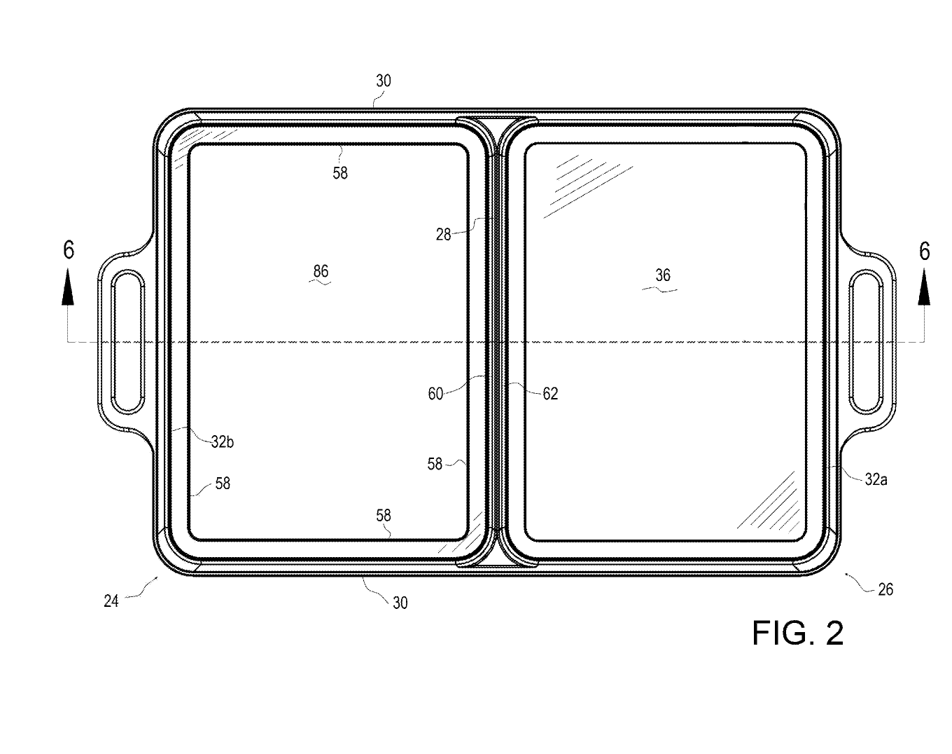

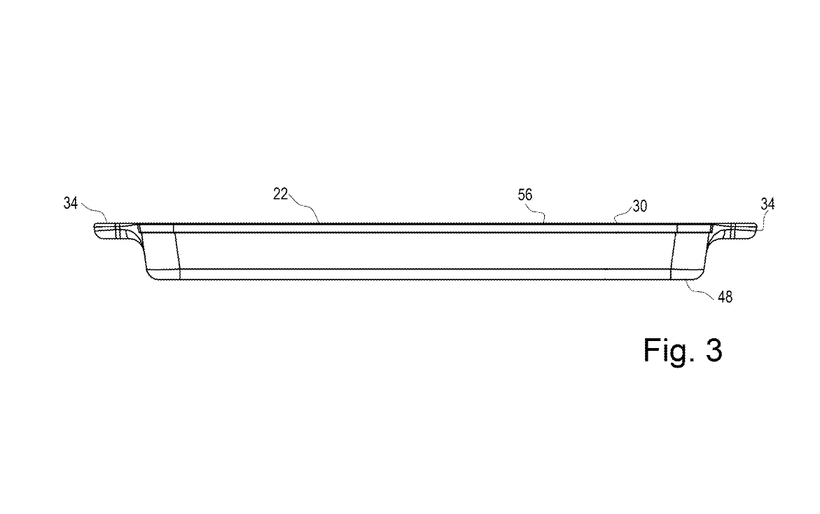

Disclosed herein is a device in several examples to be used upon the cooking surface of a barbecue grill although it may possibly be used in an oven, over a campfire, stovetop or other heating source. Generally speaking, the modular grill frame with inserts comprises two separable components. The first component being a frame portion 22, the second component is an insert to fit within the frame portion 22. This first longitudinal side defining a grill portion 24. In the example of FIGS. 1, the opposing longitudinal side of the frame 22 comprises a griddle portion 26. In use, it can be very convenient to utilize this apparatus for cooking when it is desired to simultaneously or nearly simultaneously cook items on a griddle and on a grill. For instance when it is desired to fry onions on a griddle, and grill hamburgers or other meats on a grate, and then serve the fried onions on the surface of the meat. The term “grate” used herein to cover perforated, mesh, rail, and equivalent cooking surfaces.

Before continuing with the detailed description, an axes system 10 is disclosed. The axes system comprising a vertical axis 12, a transverse or lateral axis 14, and a longitudinal axis 16. FIG. 20 also shows a radial axis 18 centered upon the circumferential center of this example of a frame 22A. These axes are intended for use in description and are not intended to limit the device to a particular orientation which may change, such as when the apparatus is not being used as a cooking utensil.

Looking to FIG. 1, the frame portion 22 can be easily seen comprising a grill portion 24 and a griddle portion 26. A transverse divider 28 may be provided to clearly separate the grill portion 24 from the griddle portion 26 so as to keep foodstuffs cooked on either side from prematurely combining. The transverse divider 28 has a first longitudinal side 60 adjacent the grill portion 24, and a second longitudinal side 62 adjacent the griddle portion 26. Additionally, this example of the frame portion 22 comprises sidewalls 30 and end walls 32. A plurality of handles 34 are also shown in this example on opposing sides of the frame. These handles 34 are very useful for repositioning the apparatus after cooking for example to move the cooked food from the heat source to a serving table while the food and possibly the frame are still hot. Generally speaking, foodstuffs are commonly cooked directly on a grilling surface such as the grate of a barbecue grill and then removed therefrom with a fork, spatula, tongs etc. onto a serving plate or similar apparatus. The serving plate is then transferred to the serving table. Often, the food is placed on a cold serving plate which clearly reduces the temperature thereof. Such temperature reduction prior to serving is normally not desired. Thus, by providing cookware which can be cooked directly thereupon, and then transferred directly to a serving table with the food still thereon, the cookware retains the heat collected during cooking and reduces thermal losses during transportation. If thermally insulated handles or handle covers are not provided, a thermally insulating pot holder, glove etc. may be used to protect the cook and the serving table surface.

To enhance the thermal retention and thermal transmission aspects of the overall apparatus, the apparatus may be cast of iron, aluminum, heat transmitting glass, polymers, or other materials provided that sufficient rigidity and thermal transmission is considered in material selection. It will be desired that in high heat applications, the material comprising the apparatus not be negatively affected by heat. To ease in manufacture and to provide a rigid and aesthetically pleasing apparatus, the entire frame portion 22 optionally including the griddle portion 26, may be cast as a unitary structure. The term “unitary structure” used herein defines an object which is substantially homogenous in the construction material and free from fasteners, welds, and other such attachment methods and apparatus.

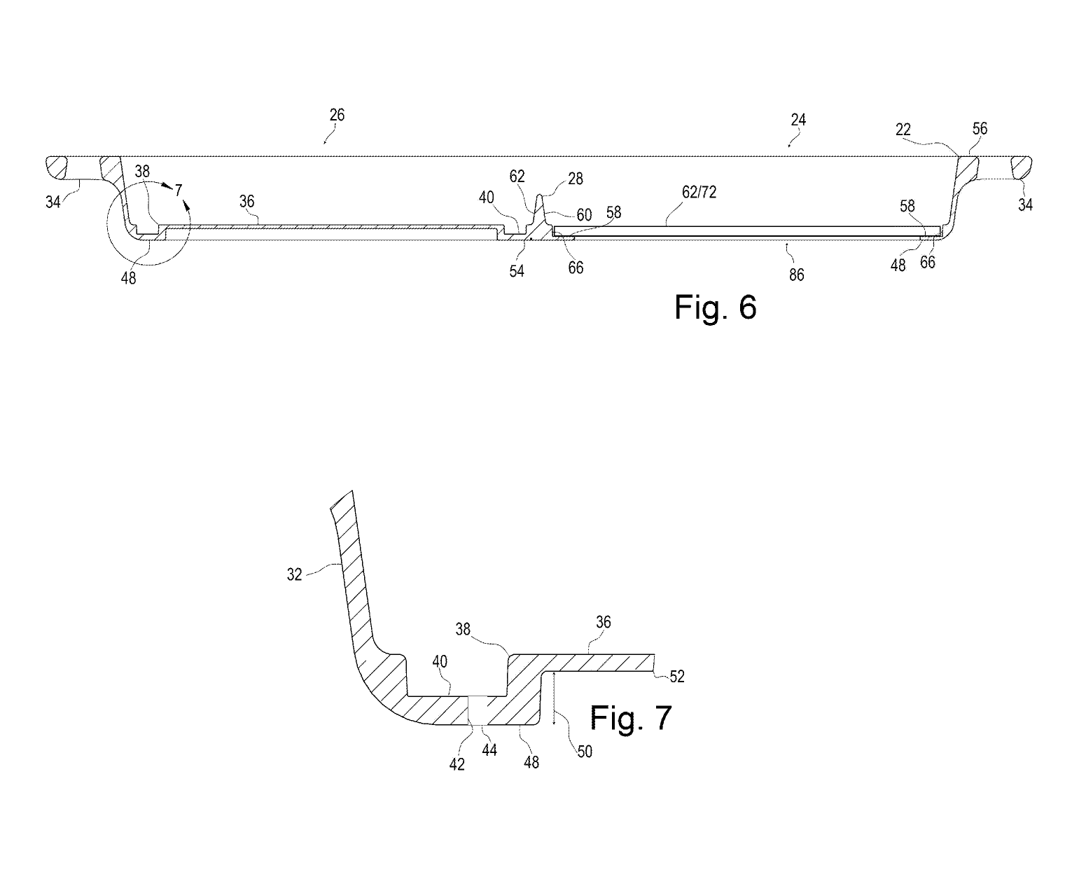

Looking to the cross sectional view of FIG. 6, it can be seen how the griddle portion 26 comprises a substantially planar (flat and residing in a plane) grilling surface 36. Additionally, outward of the perimeter edge 38 may be provided a recess comprising a grease channel 40 between the grilling surface 36 and the end wall 32. The grease channel 40 may also be provided between the grilling surface 36 and the sidewalls 30 as well as between the grilling surface 36 and a second longitudinal side the transverse divider 28. In some applications, surfaces 42 defining drain holes 44 may be provided in the bottom of the grease channel 40 to allow grease, and other fluids to drain out of the grease channel 40. Where the apparatus may be used more exclusively on a stovetop for example, it may be desired to retain the fluids, and these drain holes 44 may not be provided.

FIG. 6 also quite clearly shows a perimeter foot 48 which encircles the apparatus such that the apparatus rests upon the perimeter foot 48 when it is placed on a planar or overall planar surface such as a flat tabletop, parallel surface bars or a grate of a barbecue grill etc. As can be seen in FIGS. 6 and 7, there may be provided a vertical offset 50 between the perimeter foot 48 and the lower surface 52 of the grilling surface 36. In one example, this vertical offset allows the grilling surface 36 to be cast in a relatively thin sheet while the structure of the perimeter foot 48 provides sufficient rigidity to the overall apparatus.

Looking to FIG. 6, it can be seen how in this embodiment, the transverse divider 28 extends vertically above a center foot 54.

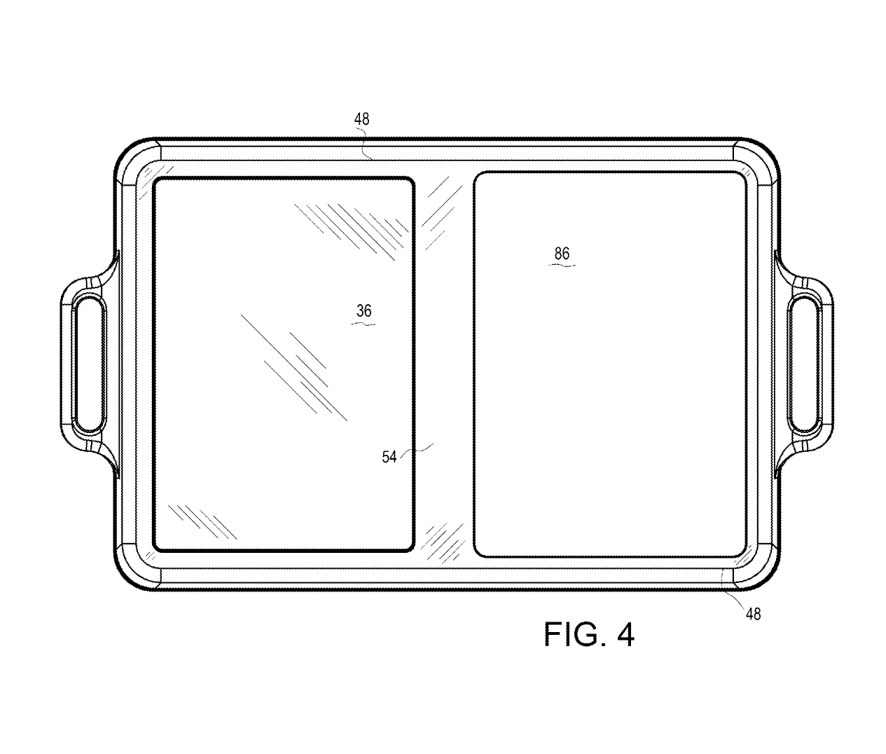

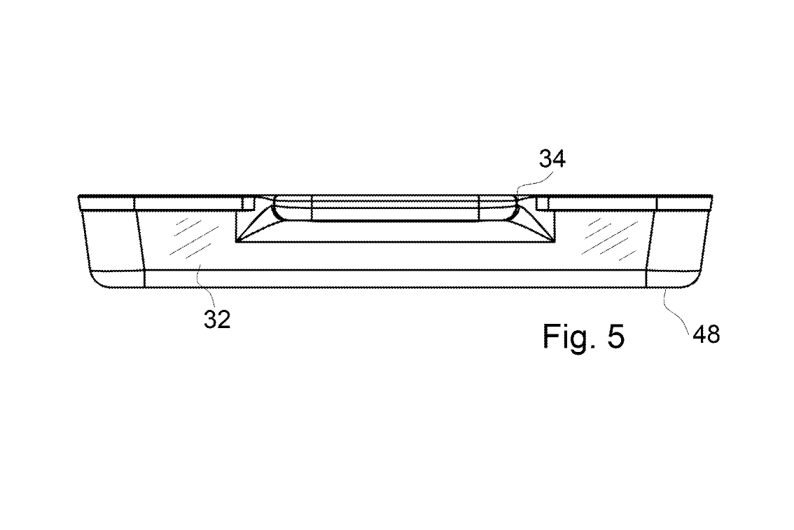

The perimeter foot 54 can also be easily seen in the bottom view of FIG. 4. FIG. 6 also shows how in this embodiment, the transverse divider 28 extends vertically above the center foot 54 and the grease channel 40, but does not extend to the upper edge 56 of the frame portion 22. In other examples, the transverse divider may extend vertically to the upper edge 56 of the frame portion 22.

FIG. 6 also shows an insert shelf 58 which extends inward from the transverse divider 28 toward the center or open region 86 of the grill portion 24. This open region 86 providing unrestricted exposure of the bottom of the underside of the cooking insert to the heat source below the overall assembly. This example of the insert shelf 58 also extends from the first longitudinal side 60 of the transverse divider 28 and as can be seen in FIG. 2 extends inward towards the open region 86 from the end wall 32b. The insert shelf 58 may also or alternatively extend inward from the sidewalls 30.

A numbering system is used herein wherein a general element is disclosed and described with a numeric identifier and when substantially identical elements are provided, they may be distinguished with an alphabetic suffix. For example, the end walls are numbered 32 whereas the end wall nearest the grill portion is labeled 32b and the end wall nearest the griddle portion 26 is labeled 32a.

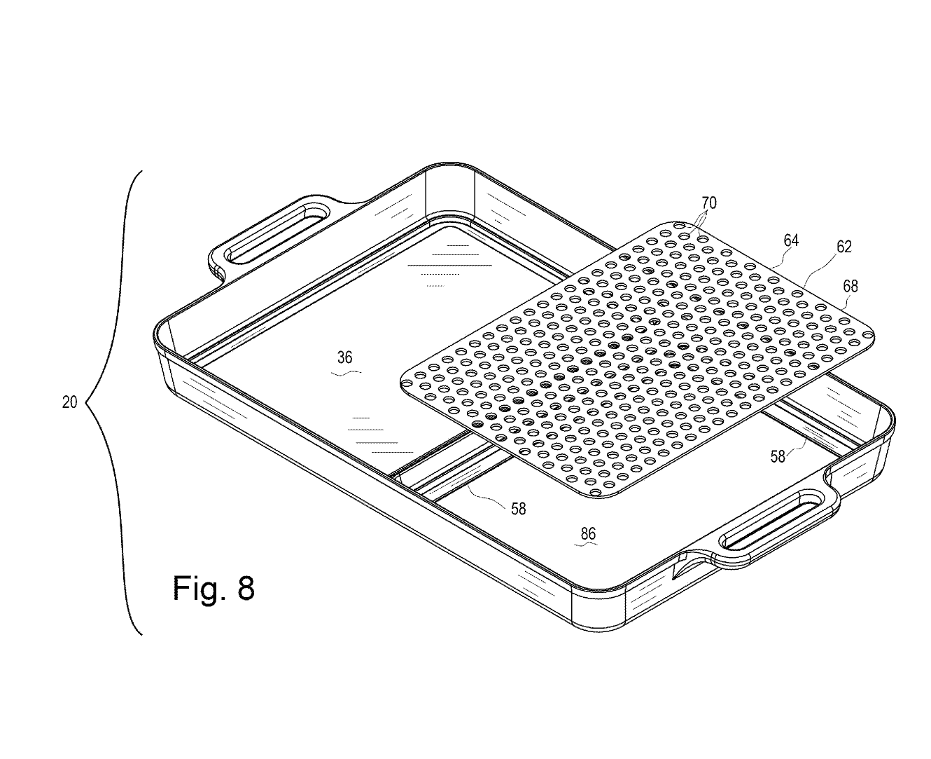

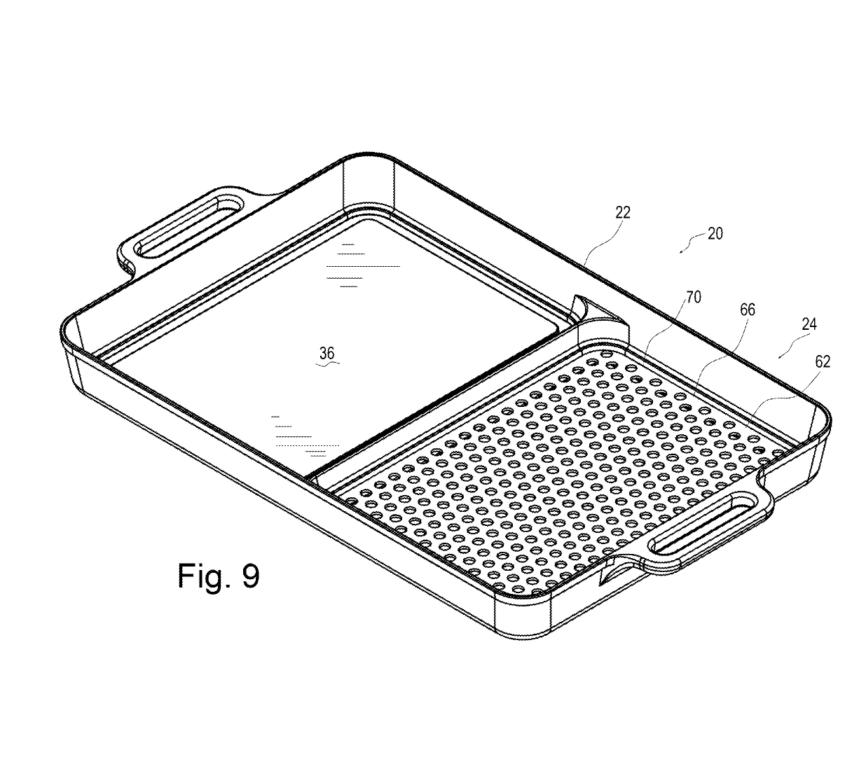

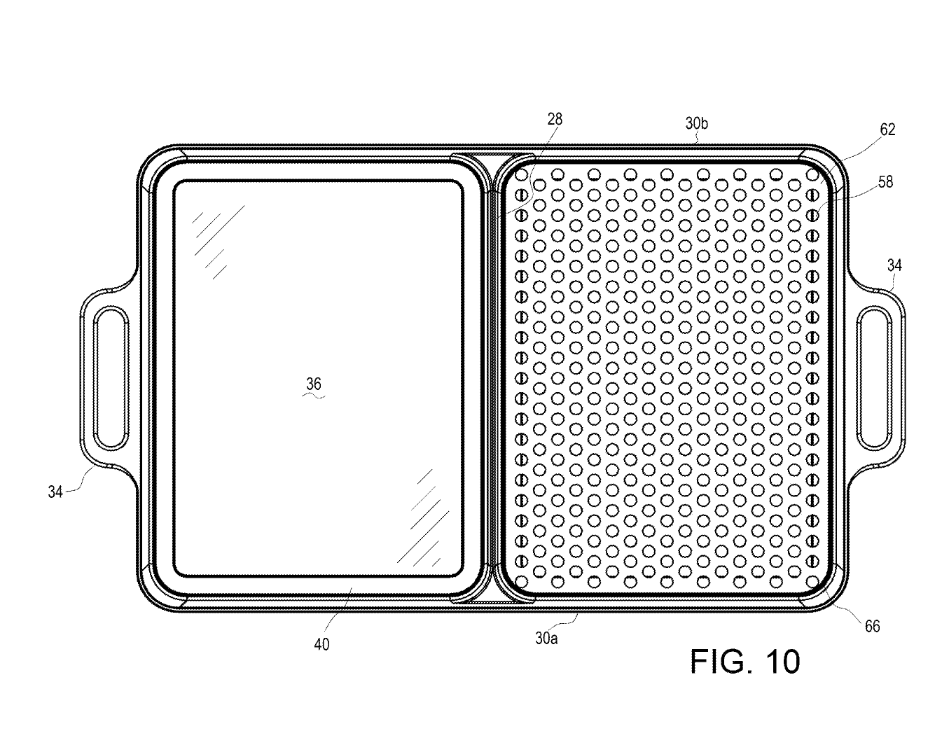

The grill portion 24 is not substantially useful without at least one cooking insert to provide a cooking surface thereupon. Looking to FIG. 8, a perforated plate insert 62 is provided comprising a perimeter edge 64 having smaller width and length dimensions than the interior width and length dimensions between opposing vertical surfaces 66 adjacent the insert shelf 58. This example of a perforated plate insert 62 comprises a rigid plate 68 having sufficient rigidity to span the gap between opposing portions of the insert shelf 58 while food is being cooked thereupon. The plate 68 in this example comprises a plurality of perforations 70 there through to allow fluids to pass there through and to increase thermal conductivity between the heat source and the food placed upon the plate 68. Looking to FIG. 9, it can be seen how the insert 62 has been fitted into the grill portion 24 of the modular griddle and grill frame with inserts 20. Due to thermal expansion differences between the construction or material of the frame portion 22 and the insert 62, it may be desired to leave a gap 70 between the insert 62 and the vertical surfaces 66 adjacent the insert shelf 58. While this gap 70 may allow a slight repositioning of the insert 62 upon the insert shelf 58, such movement would not be significant and could be easily overcome. Support rails, corrugations, or other structures may be incorporated to increase the rigidity of the perforated plate 68.

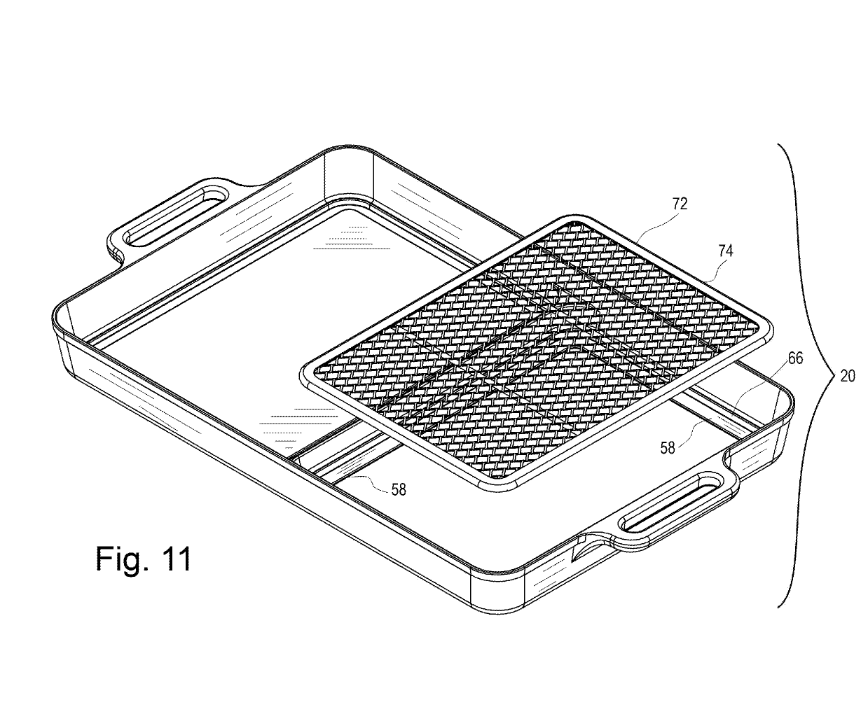

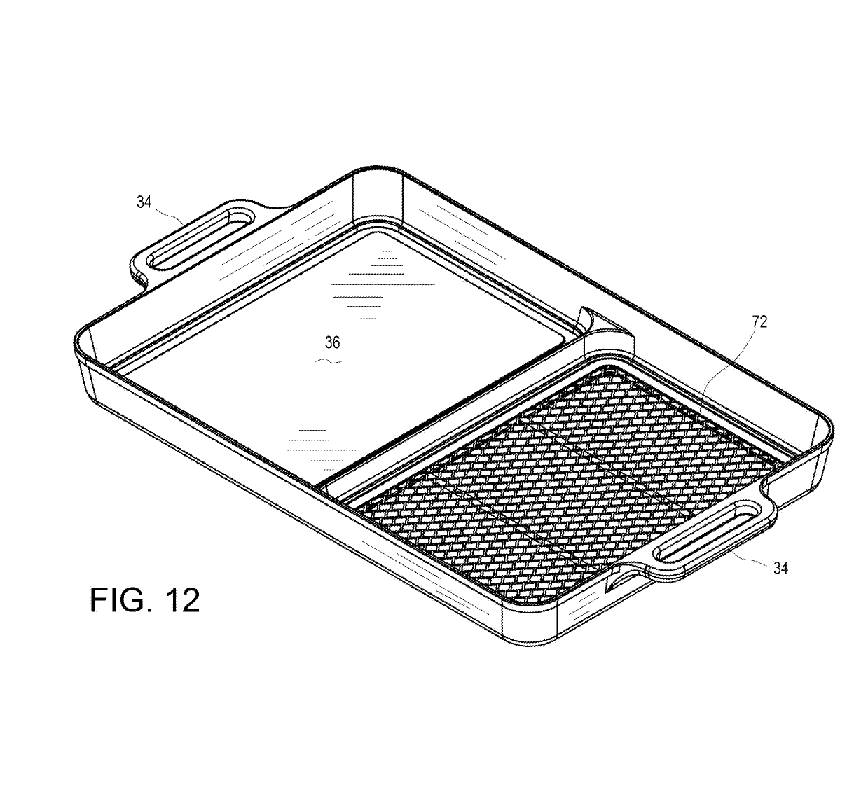

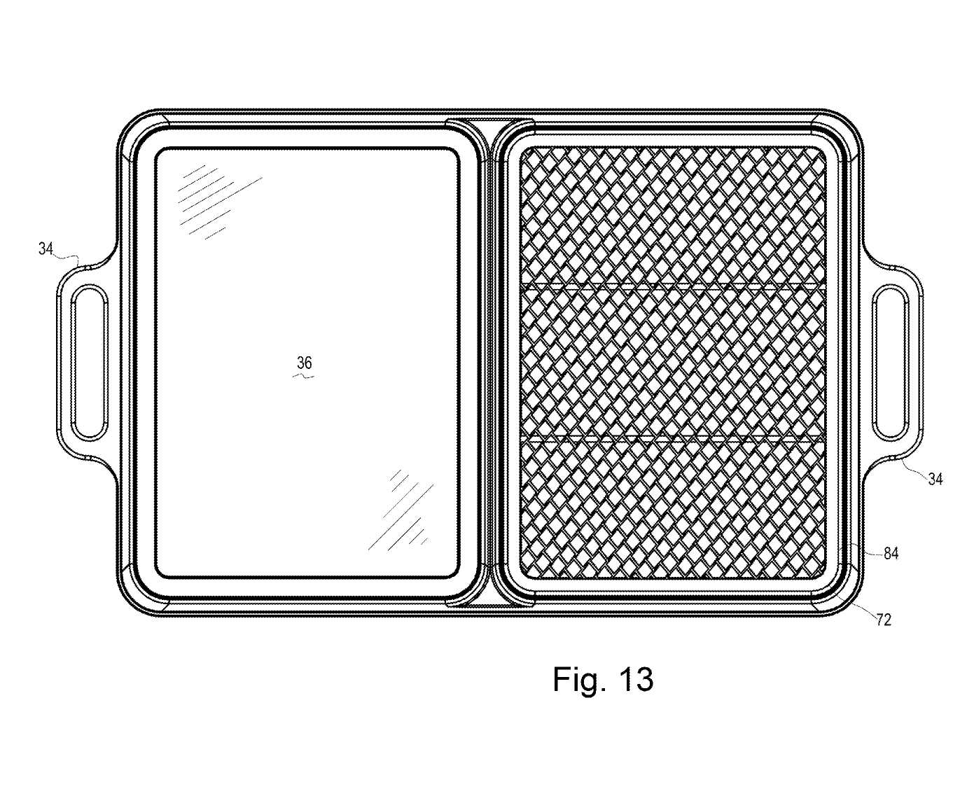

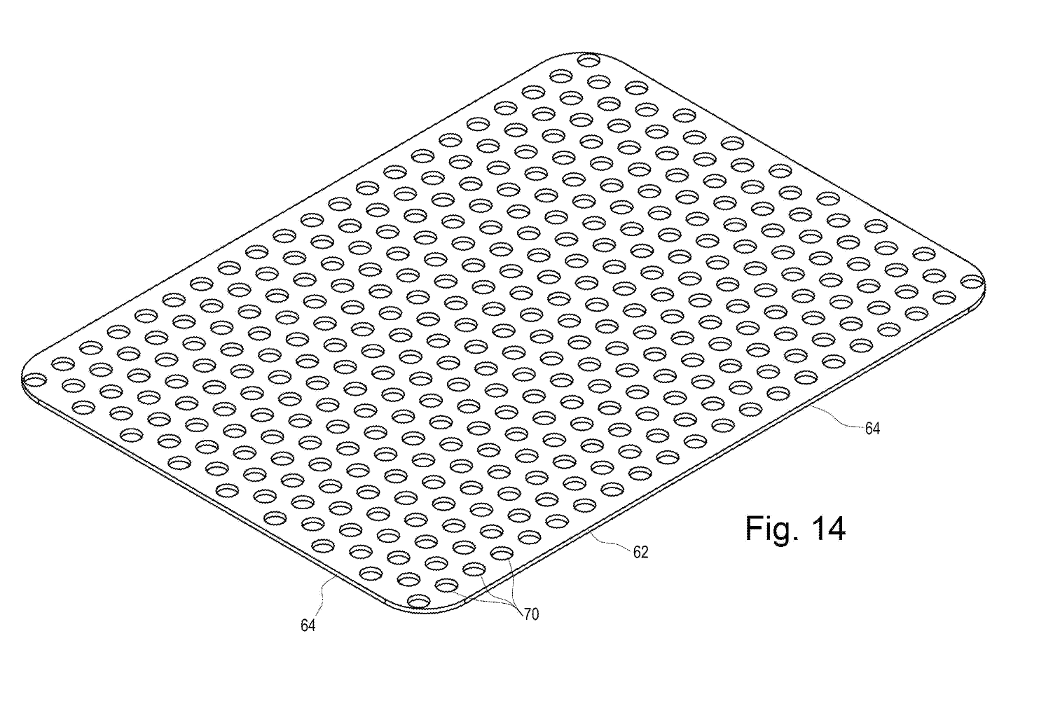

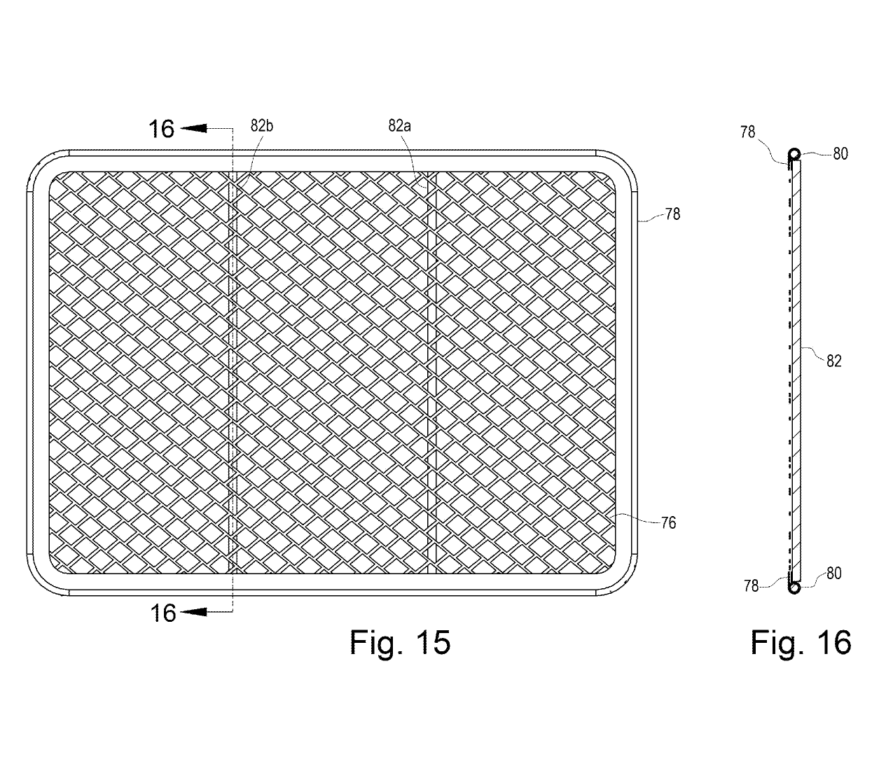

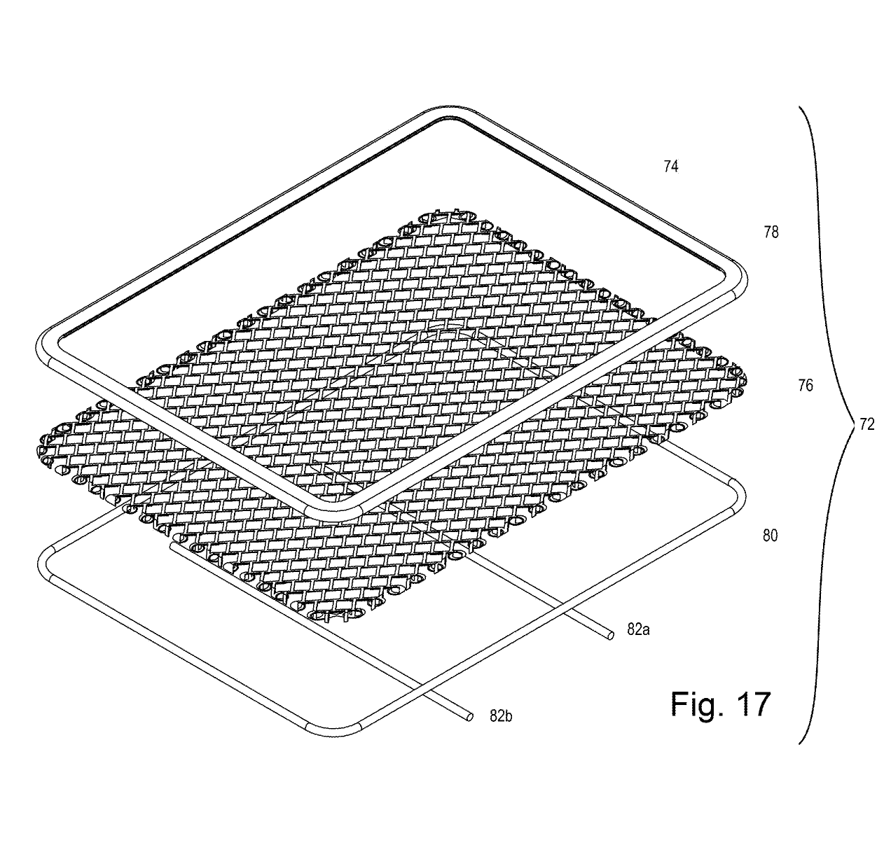

Looking to FIG. 11, a mesh insert 72 is provided comprising a perimeter edge 74 also having smaller width and length dimensions than the interior width and length dimensions between opposing vertical surfaces 66 adjacent the insert shelf 58. This example of a mesh insert 72 comprises several interoperating components as shown in FIG. 17. Also, it is conceived as a single mesh component similar to that of element 76 of FIG. 17 may have sufficient rigidity to span the gap between opposing sides of the insert shelf 58.

FIG. 17 shows a particular example of the mesh insert 72 with a perimeter edge 74 wherein the mesh insert 72 comprises several interoperating components to add aesthetic value, rigidity, and aid in cleaning of the insert 72. While several different combinations are possible, the insert 72 shown in FIG. 17 comprises an upper grill perimeter frame 78 fitted above a heat resistant mesh 76 and both of these elements may be fitted above a lower grill frame 80 which may have cross frames 82 welded or otherwise attached thereto. In one form, once in place the upper grill perimeter frame 78 is crimped around the edges of the heat resistant mesh 76 and lower grill frame 80. In this example, the lower grill frame 80 is substantially cylindrical in cross section including the cross frames 82. As previously defined relative to the perforated plate insert 62, a gap 84 may be provided between the perimeter edge 74 of the insert 72 and the vertical surfaces 66 of the frame portion 22.

As the mesh insert 72 would likely have very little thermal expansion, the gap 84 may not be necessary.

One additional benefit of this apparatus is that the grilling surfaces (grate) of barbecue grills etc. often need to be replaced due to wear, heat abuse, and oxidation enhanced by heat and food particles retaining moisture. With this disclosed apparatus, it is a relatively simple method and apparatus to replace the insert of the grill portion 24 at will as it is relatively small. As the apparatus 20 can be utilized on barbecue grills of many different sizes, shapes and configurations, this may significantly reduce or eliminate the need to replace the BBQ grate. Specifically, where a barbecue grill may be out dated, use of the disclosed apparatus 20 can allow a user to cook upon a clean and substantially undamaged surface.

Additionally, due to the ease of removal and reduced size of the grill portion 22, it may be convenient for the user to remove the insert and clean it using a dishwasher or equivalent apparatus where this is substantially not possible with most barbecue grill surfaces.

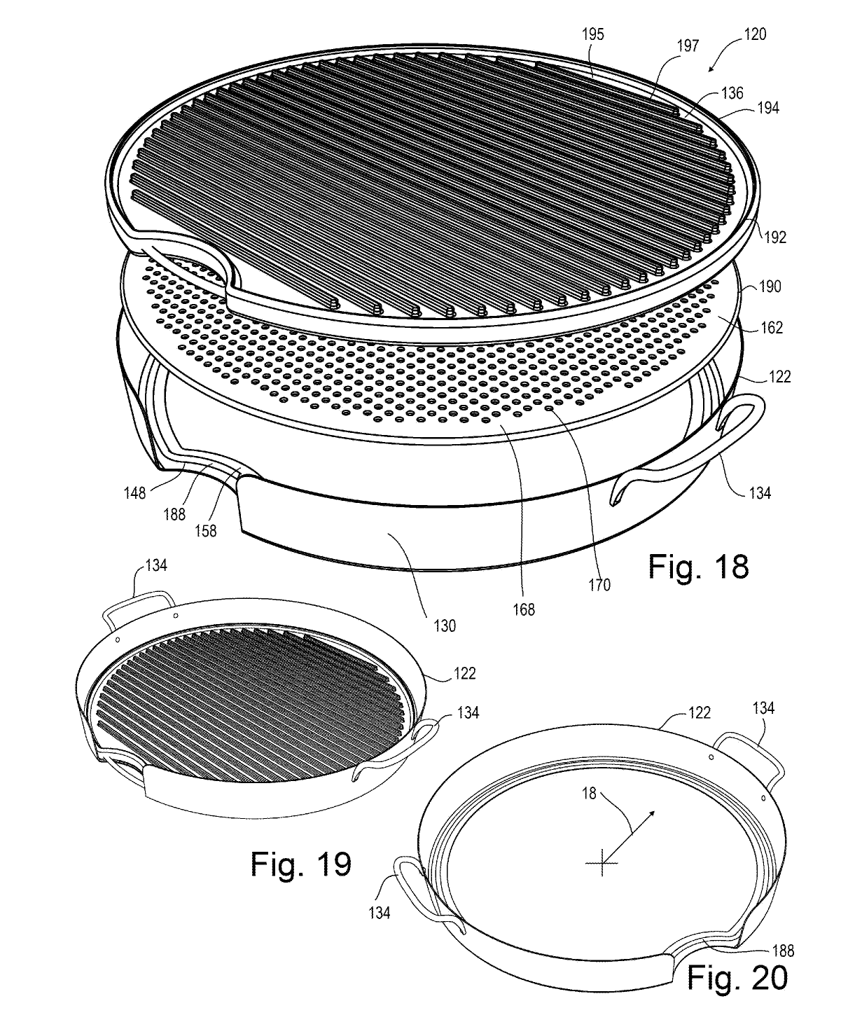

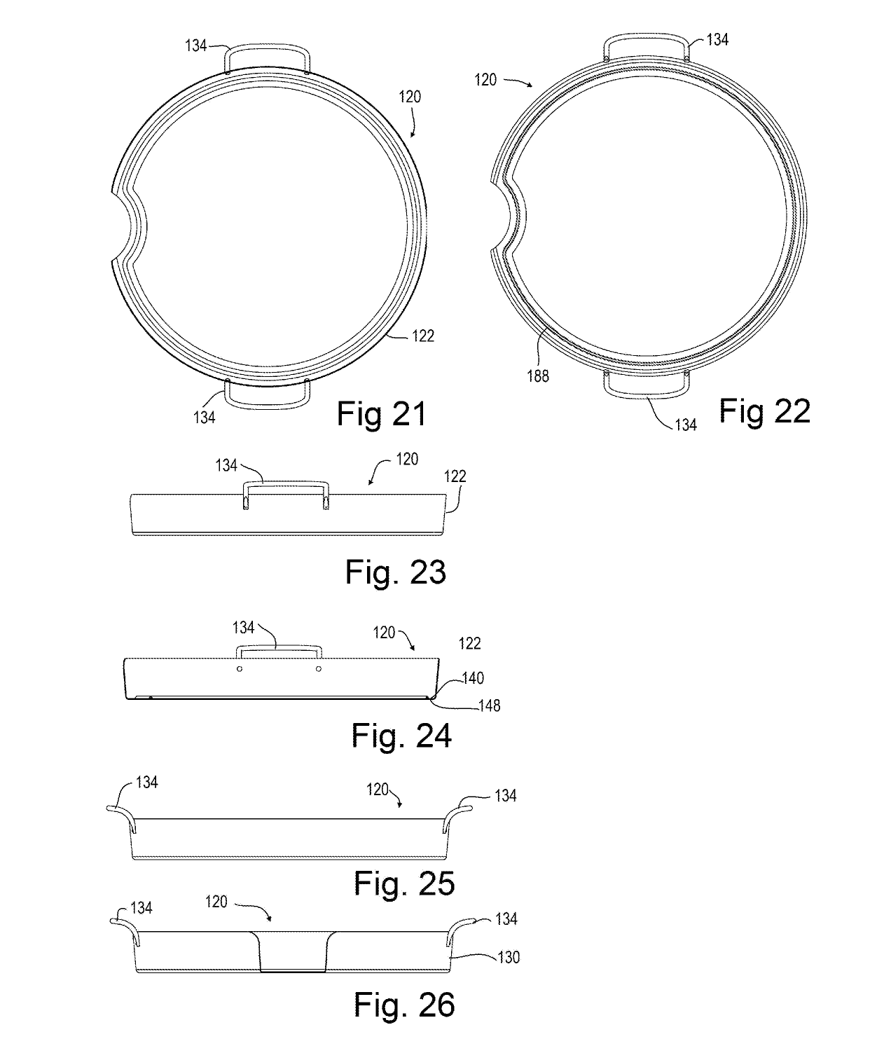

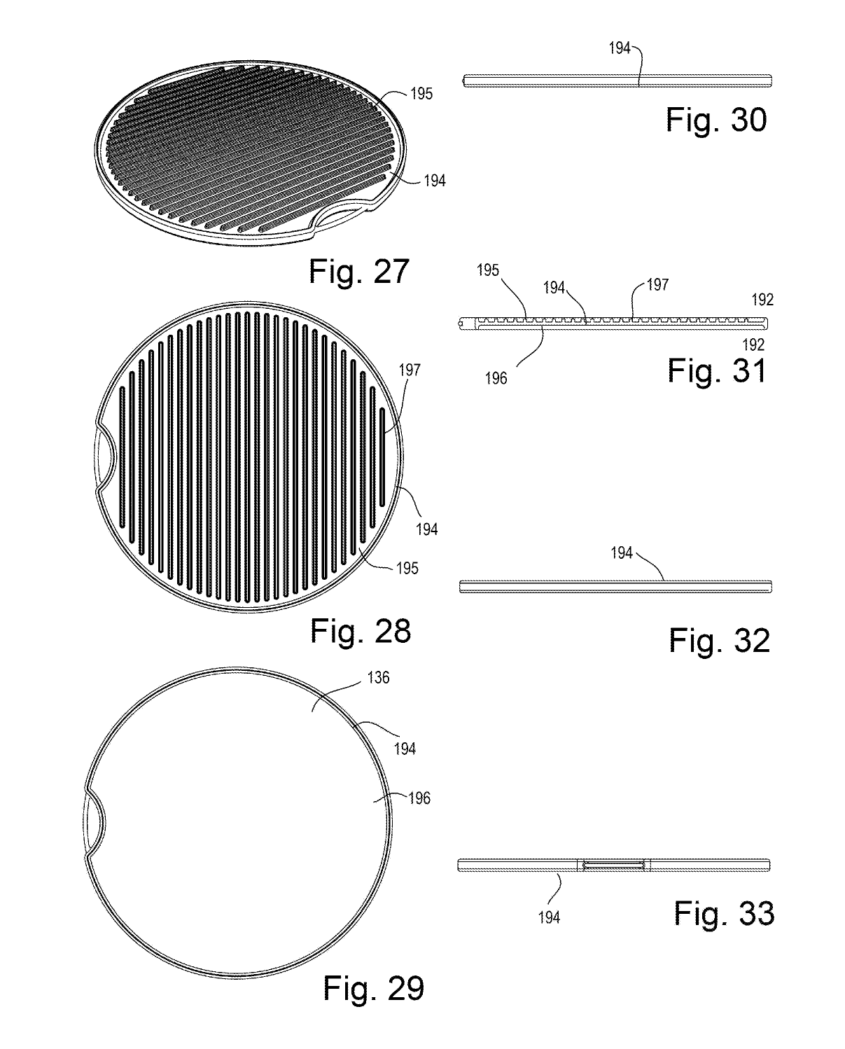

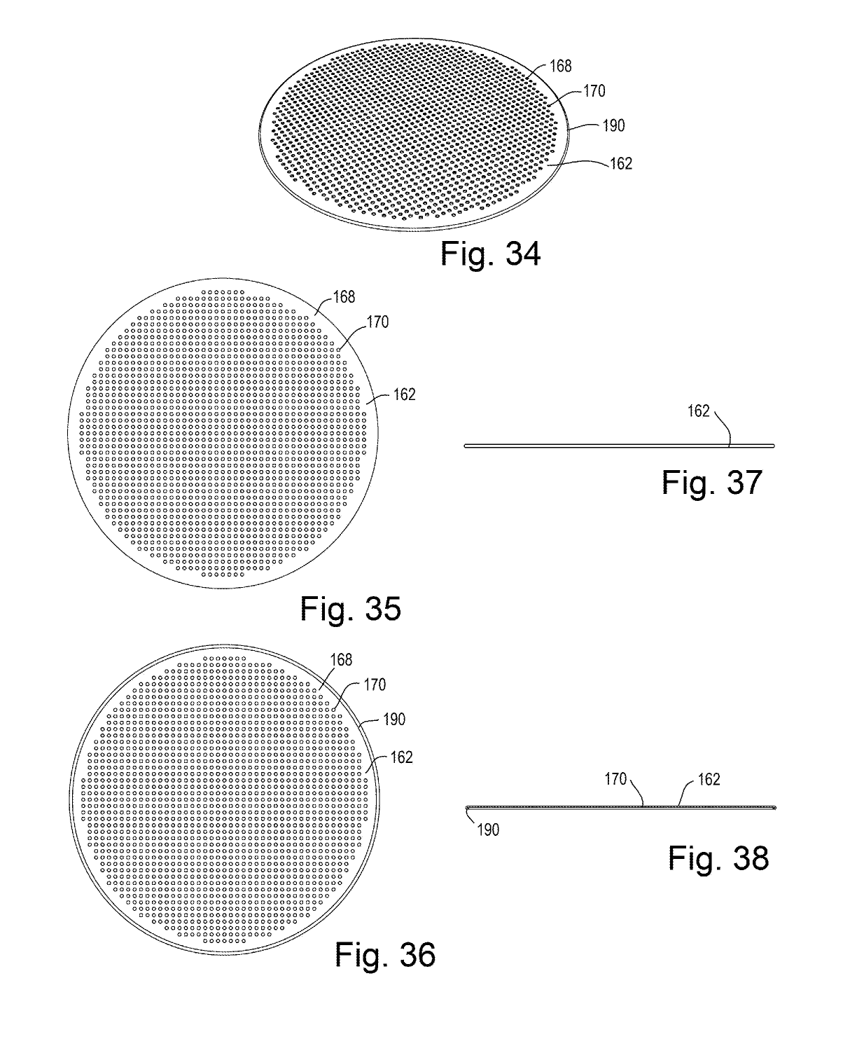

FIGS. 18-36 show a similar apparatus of a modular grill frame with inserts 120. In this example, components similar to those of the other examples have similar labels with a 1 prefix. For example, the perimeter frame 122 of this example is similar to the perimeter frame 22 of the first example. It is also to be understood that concepts and components of the other examples may be interchanged with the concepts and components of this example.

In this example the insert shelf 158 comprises a ridge 188 which cooperates with a perimeter ridge 190 of the perforated plate 162, perimeter ridge 192 of the grilling panel 194, or similar perimeter ridges of other cooking inserts. The perimeter ridge 192/194 of the cooking insert fits radially outward of the ridge 188 and in cooperation therewith holds the cooking insert 162/194/etc in proper position.

This example also shows a reversible grilling panel 194 having a perimeter ridge 192 on a first vertical side 195 and second vertical side 196 thereof. The first vertical side having vertically projecting grilling ridges 197 projecting therefrom. The second vertical side of this example has a smooth, planar, non-permeable plate cooking surface 136. The smooth, planar, non-permeable plate cooking surface is used as the griddle 36 of the pervious example.

In this example, the sidewall 130 has an opening therein. This opening providing easy access to the grilling panel 194, perforated plate 162, or mesh plate. For example, FIG. 18 clearly shows that an example where a lifting and carrying handle is provided on the grilling panel 194 which is easily accessed via the opening in the sidewall 130.

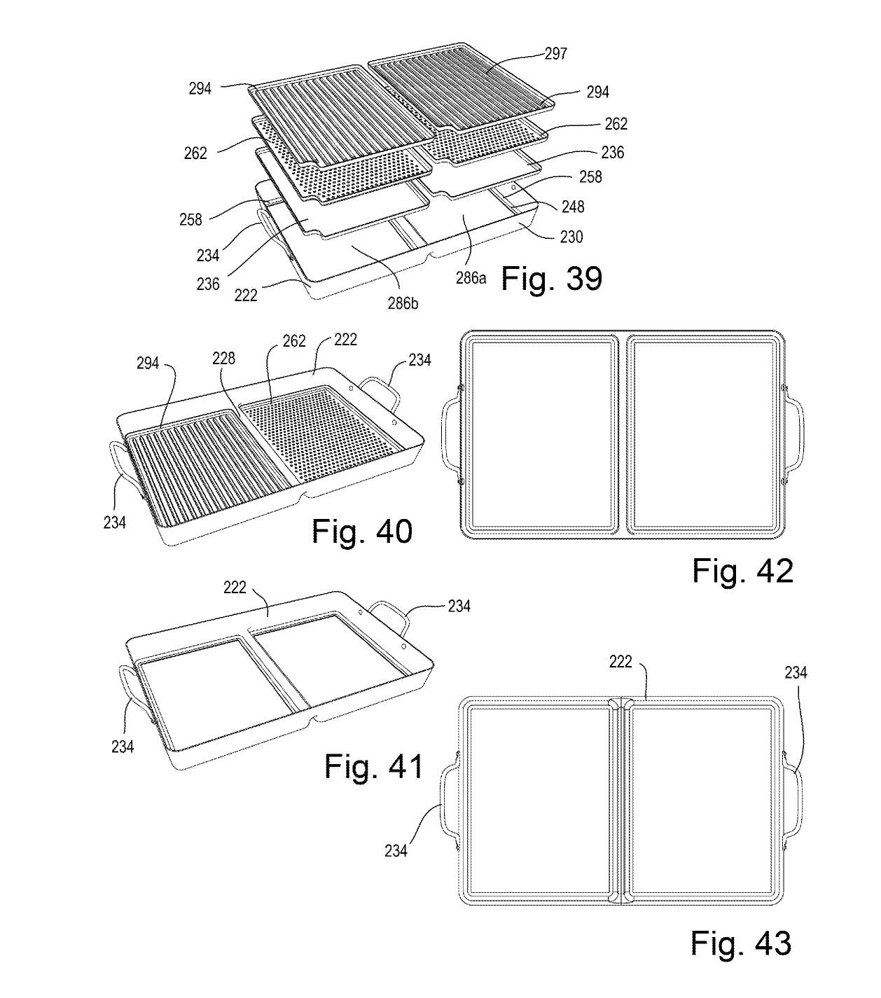

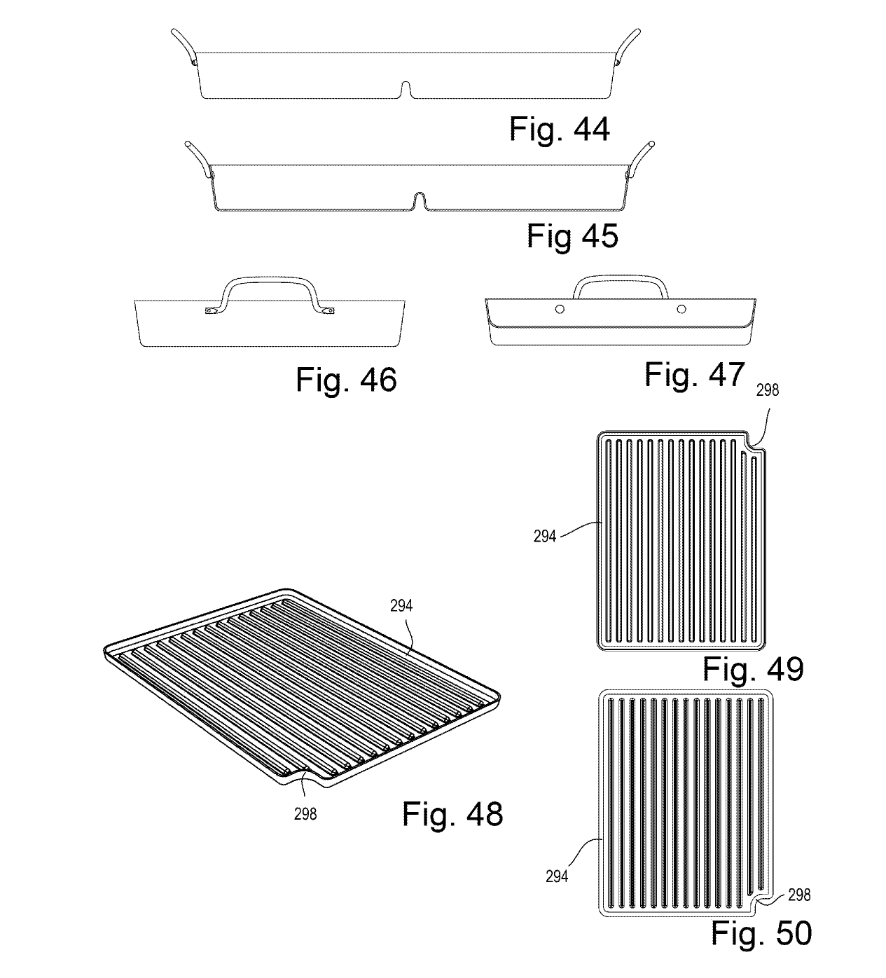

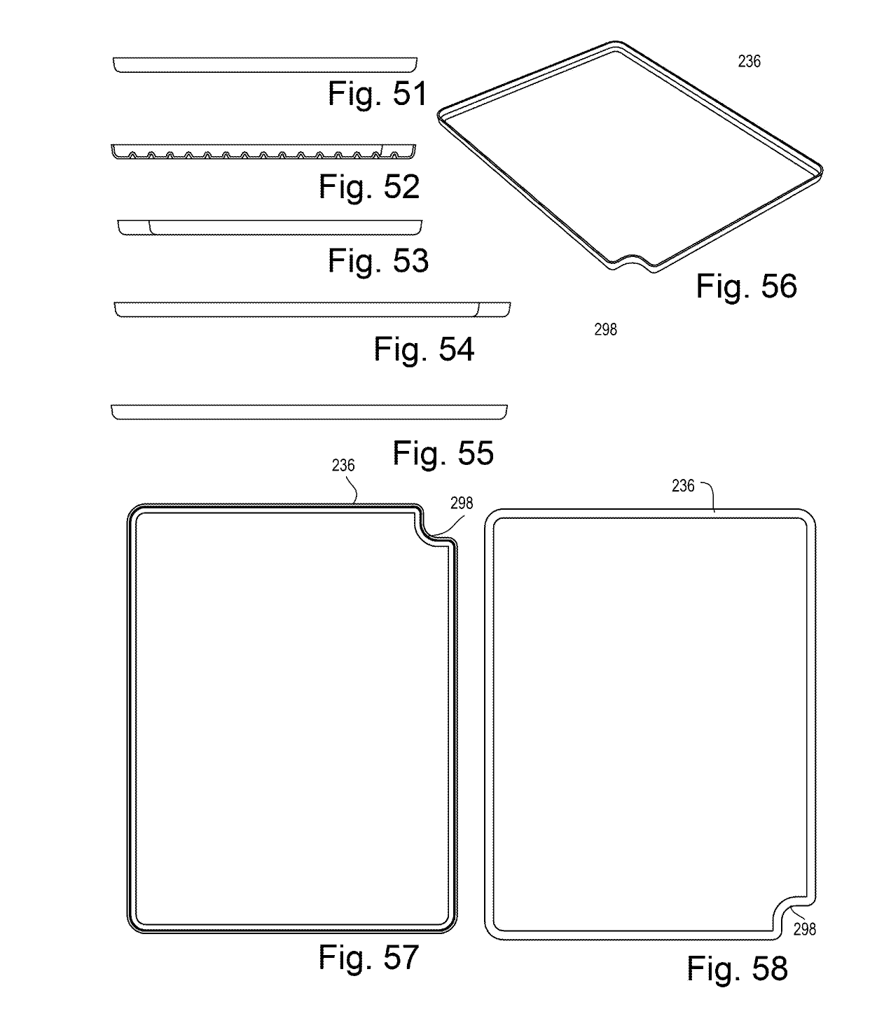

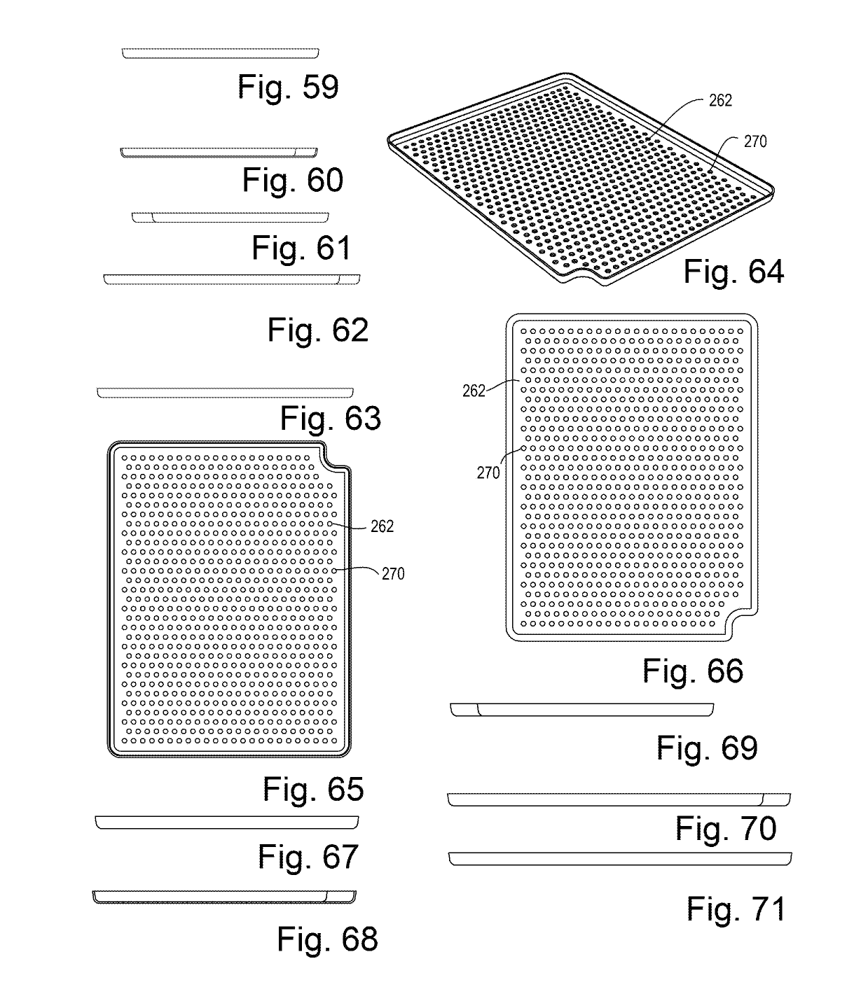

FIGS. 39-71 show another example, substantially a combination of the previous examples where labels where components similar to those previously shown have a numeral 2 prefix. The perimeter frame 222 similar to the perimeter frame 22 of the previous example and having many of the details disclosed above. On difference being that the transverse divider 228 divides the perimeter frame 222 into two open regions 286a/286b. Grilling inserts such as the grilling panel 294 having vertically projecting ridges 297, a perforated plate 262, and/or a griddle surface 236 may be interchangeably inserted in either side 286a/286b of the device as desired. This can be accomplished in that each of the inserts has a substantially identical perimeter sidewall and thus can be interchanged. A kit may be provided to a customer containing to of each of the grilling panel 294 having vertically projecting ridges 297, a perforated plate 262, mesh plate 72, and griddle surface 236 to allow the customer the widest variety of options.

Each of the cooking inserts as shown may have a cutout corner 298 for easy removal of the insert from the perimeter frame 222.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

1. A modular grilling assembly comprising:
a grilling frame being thermally conductive and having a vertically extending side wall, and a lowermost portion forming a perimeter foot;
the grilling frame defining a cooking region;
wherein the cooking region comprises a surface defining an insert shelf at a lower, the insert shelf forming an edge of a hole through a bottom of the second cooking region;
wherein the cooking region includes opposing vertical surfaces surrounding and adjacent to the insert shelf to form a recess to support a cooking insert; and
the cooking insert removably positioned on the on the insert shelf covering the cooking region;

2. The modular grilling assembly as recited in claim 1 wherein the cooking insert comprises a perforated plate cooking surface fitted within and removably resting upon the insert shelf.

3. The modular grilling frame as recited in claim 1 wherein the cooking insert comprises a non-permeable plate cooking surface fitted within and removably resting upon the insert shelf.

4. The modular grilling frame as recited in claim 1 wherein the cooking insert comprises a non-permeable plate cooking surface having vertically projecting ridges on a first vertical side thereon, the cooking surface fitted within and removably resting upon the insert shelf.

5. The modular grilling frame as recited in claim 4 wherein the cooking insert comprises a smooth and planar non-permeable plate cooking surface on a second vertical side thereon, the cooking surface fitted within and removably resting upon the insert shelf.

6. The modular grilling frame as recited in claim 1 wherein the cooking insert comprises a mesh insert cooking surface fitted within and removably resting upon the insert shelf.

7. The modular grilling assembly as recited in claim 5 wherein the mesh insert cooking surface comprises:
upper a mesh insert perimeter frame;
a heat resistant mesh extending across and in contact with the upper mesh insert perimeter frame; and
a lower mesh insert perimeter frame attached to the upper grill frame and in contact with the perimeter of the heat resistant mesh.

8. The modular grilling assembly as recited in claim 1 further comprising horizontally opposed lifting handles.

9. A modular grilling assembly comprising
the grilling frame being thermally conductive and having a longitudinal dimension defined by first and second laterally opposed side walls, a transverse dimension defined by longitudinally opposed first and second end walls;
a cooking region bounded by the second longitudinal end wall the first side wall and the second side wall
wherein the cooking region comprises a surface defining an insert shelf, the insert shelf defining a hole through the modular grilling frame;
a cooking insert removably positioned on the on the insert shelf covering the cooking region;
wherein the cooking insert comprises an upper grill perimeter frame;
wherein the cooking insert further comprises a heat resistant mesh extending across and in contact with the upper grill frame;
wherein the cooking insert further comprises a lower grill perimeter frame attached to the upper grill frame and in contact with the perimeter of the heat resistant mesh; and
wherein the cooking insert further comprises at least one cross support vertically below the heat resistant mesh, in contact with a lower surface of the heat resistant mesh, and attached to the lower grill perimeter frame.

10. The modular grilling assembly as recited in claim 9 wherein the grilling frame is cast as a single body.

11. The modular grilling assembly as recited in claim 10 wherein the modular grilling frame is cast of iron.

12. The modular grilling assembly as recited in claim 9 further comprising a grease channel longitudinally outward of and vertically below the plane of an upper surface of the insert shelf, longitudinally between the griddle surface and the end wall, laterally between the griddle surface and each side wall, and longitudinally between the griddle surface and the transverse divider.

13. The modular grilling assembly as recited in claim 9 further comprising horizontally opposed lifting handles.
